(19) United States
(12) Patent Application Publication
(10) Pub. No.: US 2025/0077905 A1
(43) Pub. Date: Mar. 6, 2025

(54) WEIGHTED NODES IN CONCEPTUAL CONTENT MAPPING

(71) Applicant: OBRIZUM GROUP LTD., Cambridge (GB)

(72) Inventors: Chibeza Chintu AGLEY, Cambridge (GB); Vishnu HARIHARAN ANAND, Cambridge (GB); Christopher PEDDER, Leysin (CH)

(73) Assignee: OBRIZUM GROUP LTD., Cambridge (GB)

(21) Appl. No.: 18/614,051

(22) Filed: Mar. 22, 2024

Related U.S. Application Data
(60) Provisional application No. 63/454,198, filed on Mar. 23, 2023.

(51) Int. Cl. G06N 5/022; G06N 5/04

(52) U.S. Cl. CPC G06N 5/022; G06N 5/04

(57) ABSTRACT

A content management system generally provides the ability to “weight” various content items by assigning weights to various content, ultimately weighting or skewing a knowledge base towards particular or weighted content during the contextualization process. Weighting nodes and/or weighting a content discovery algorithm may result in content items and concepts represented by the content items being considered more heavily by algorithms creating content groupings. An example method includes generating a knowledge base that includes a plurality of nodes representing a respective plurality of content items and updating the knowledge base based on a received user feedback, where the user feedback corresponds to a weighting for one or more content items. Content groupings are generated based on the updated knowledge base, where the content groupings include subsets of the plurality of content items and the subsets include conceptually similar content items. The generated content groupings are provided via a user interface.

### CROSS REFERENCE TO RELATED APPLICATIONS

This application claims priority to U.S. Provisional Application No. 63/454,198 titled “WEIGHTED NODES IN CONCEPTUAL CONTENT MAPPING” filed Mar. 23, 2023, which is incorporated by reference for all purposes herein.

### TECHNICAL FIELD

The present disclosure relates generally to content management systems and examples of emphasizing subjects or content items within content management systems.

### BACKGROUND

Content management systems may be used to store and provide educational content. In some examples, the educational content may be grouped into concepts without human input. Such groupings may be used to provide content representative of all groupings to various end users. However, when new content is added to such content management systems, the new content may not fit into the existing groupings. Similarly, the emphasis or focus of select content as generated by machine learning methods may be different from a desired focus, i.e., certain content items are deemphasized by the machine learning methods but may be important overall for the educational system or to the user. Accordingly, end users may not be presented with content that is related to new or otherwise underrepresented content within the content management system.

### SUMMARY

An example method disclosed herein includes generating a knowledge base including a plurality of nodes representing a respective plurality of content items and updating a knowledge base based on a received user feedback, where the user feedback corresponds to a weighting for one or more content items. Content groupings are generated based on the updated knowledge base, where the content groupings include subsets of the plurality of content items and the subsets include conceptually similar content items. The generated content groupings are provided via a user interface.

An example method disclosed herein includes receiving, via a user interface, a selection of a content item for creation of a weighted node corresponding to the content item. The user interface is configured to receive input to create the weighted node by adjusting a weight of a node representing the selected content item, where the node represents the content item in a knowledge base including a plurality of nodes representing a plurality of content items. The method further includes displaying, via the user interface, a representation of content groupings of the plurality of content items in the knowledge base, where the content groupings are determined based on the plurality of nodes and the weighted node.

Example systems disclosed herein include a processor and a memory. The memory stores instructions, that when executed by the processor, cause operations to be performed. The operations include generating a knowledge base including a plurality of nodes representing a respective plurality of content items, where the knowledge base represents a first set of relationships between the plurality of content items and updating the knowledge base based on a received weight for a selected node of the plurality of nodes of the knowledge base, where the updated knowledge base represents a second set of relationships between the plurality of content items. Content groupings are generated based on the updated knowledge base, where the content groupings include subsets of the plurality of content items and the subsets include conceptually similar content items. The generated content groupings are provided via a user interface.

Additional embodiments and features are set forth in part in the description that follows and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example system including a content management system, in accordance with various embodiments described herein;

FIG. 2 is a schematic diagram of an example computer system implementing various embodiments in the examples described herein;

FIG. 3A illustrates a first example knowledge base in accordance with various embodiments described herein;

FIG. 3B illustrates a second example knowledge base updated with weighted nodes in accordance with various embodiments described herein;

FIGS. 4A-4E illustrate example user interfaces showing concept groupings of content items with and without weighting of one or more nodes within a knowledge base in accordance with various embodiments described herein;

FIGS. 5A-5E illustrate additional example user interfaces showing concept groupings of content items with and without weighting of one or more nodes within a knowledge base in accordance with various embodiments described herein;

FIG. 6 is a flowchart illustrating an example method of generating content groupings in a knowledge base in accordance with various embodiments described herein;

FIG. 7 is a flowchart illustrating an example method of generating content groupings using weighted nodes in a knowledge base through input from a user interface in accordance with various embodiments described herein; and

FIG. 8 is a flowchart illustrating an example method of using weighted nodes to manage multimedia content across multiple languages in accordance with various embodiments described herein.

### DETAILED DESCRIPTION

The content management system described herein may generally use a process of contextualization to create a knowledge base representing various content items grouped according to concepts represented by or reflected within the content items (e.g., topics covered within the content items). Such a knowledge base may be used to, for example, to provide trainings or other types of real time learning by ensuring that participants are presented with content items from the representative concept groups and/or demonstrate knowledge of the various concept groups. For example, trainings centered around a particular concept group or topic may display content focused on or including those concepts, and eliminate or not present irrelevant content. This allows for a better use of time for the user (i.e., training time is not wasted in watching or consuming off-concept content) and can increase understanding much faster than conventional linear learning techniques.

The contextualization process may process the content items to generate a corpus, generate a probability model to identify concept groupings within the corpus, and generate a knowledge model including nodes representing the content items and edges between the nodes representing the relationships between content items. In other words, the contextualization may mathematically (e.g., graphically) represent relationships of any given content to all other content, which allows for related content (e.g., similar concepts covered within the content) to be referenced and consumed easily by a user. For example, such knowledge models may be used to present content to users, e.g., an online course may present initial content from various content groupings to ensure users are presented with content representing key concepts in the course. In some examples, content items may include assessment items, to gauge how well a user understands the concepts provided in the course. Where a user is having difficulty with a particular concept, the knowledge model may be utilized to provide the user with additional informational content relating to the concept. Additionally, only relevant content is presented to the user, expediting understanding and learning, by focusing the content consumption on relevant content.

Typically, a contextualization process uses a large number of content items and in some instances may miss conceptual groupings with fewer content items. For example, concept grouping techniques may attempt to generate a minimum number of conceptual groupings. In these examples, important topics may be missed due to low frequency and/or lack of a conceptual group corresponding to the topic. In other words, an automated assessment of the content may misidentify importance of certain topics or concepts due to the topic being represented by a smaller number of content items or lack of relevant content items. For example, there may be a very important topic, such as safety, that may have a single written manual describing the topic and in an automated contextualization, the low representation of the topic may be correlated incorrectly with a lower importance to the user in the overall learning space, especially if there are other topics or concepts that have multiple descriptions in various content items.

Further, such knowledge bases may be difficult to utilize with new, fast growing, and/or fast changing fields of study. For example, content involving laws or regulations may be updated when the corresponding laws and/or regulations are updated. Technology or other areas may similarly be frequently updated. Where knowledge bases are generated using large volumes of data, updating the knowledge base for a changing content area may include both generating new content reflecting the updates and/or removing out-of-date content. For frequently changing subject areas, these updates may be infeasible. For example, it may be cumbersome and/or time consuming to manually add enough content relevant to updated contents for the model to appropriately consider such updated content. Manually removing out-of-date content may be similarly cumbersome. Further, where new content is added, it may take a large volume of content related to updated concepts before the knowledge base recognizes and/or reflects the updated concepts. For example, the knowledge base may include a large volume of content related to other concepts such that the existing content greatly outnumbers the new content, and the new content is less likely to be utilized and/or presented in instructional materials.

The content management system described herein generally provides techniques to elicit feedback from a user about what content is important, interesting and/or relevant to the user in a knowledge space and to use that feedback to construct a more informative knowledge space for the user. In some embodiments, the content management system provides the ability to “weight” various content items by assigning weights to various content, ultimately weighting or skewing a knowledge base towards particular or weighted content during the contextualization process. Weighting nodes may result in content items and concepts represented by the content items being considered more heavily by algorithms creating content groupings. Accordingly, newer and/or less prominent topics may be more likely to be represented in a knowledge base and used by various processes utilizing the knowledge base. In some examples, in addition to weighting a node, the content management system may create a new content grouping based on a weighted node. Accordingly, knowledge bases may be used more efficiently and/or accurately in new or quickly changing subject areas. Further, new concepts may be added to existing knowledge bases, and content groupings may be quickly generated corresponding to the new concepts. The weighting of select content nodes helps to ensure that the knowledge space and focus on particular content topics or concepts is arranged in a desirable manner and allows dynamic re-contextualization to assist in efficient traversing of the knowledge space and presenting of content to a user.

For example, in some embodiments, a knowledge base (e.g., a graph) may represent a first space with a first set of relationships between content items. Weighting a content item in the knowledge base may effectively duplicate the text of the content item a number of times correlated to a weight assigned by the user. In some examples, weighting the content item in the knowledge base may duplicate concepts presented within the content item a number of times correlated to a weight assigned by a user. The process of contextualization may then take the text of the content item into account more than once when generating an updated knowledge base, where the updated knowledge base represents a second space with a second set of relationships between the content items. The second set of relationships between the content items may be based on the weighted content item.

In other embodiments, the content management system provides the ability to receive text from a user and, based on the received text, weight a concept discovery algorithm. The text can be, for example, a free text topic description and/or a group or string of keywords that describe a topic or topics that are interesting, important, and/or relevant to the user. In a non-limiting nonexclusive example, a prior probability distribution can be used with topic modeling to find one or more topics that are associated with the received text.

Though the content management system is described with respect to educational and/or instructional materials, such weighting and conceptual concept mapping may be used in other applications. For example, weighting of content within knowledge bases may be useful in, for example, multilingual content mapping, resume analysis, or other groupings of content.

Various embodiments of the present disclosure will be explained below in detail with reference to the accompanying drawings. Other embodiments may be utilized, and structural, logical and electrical changes may be made without departing from the scope of the present disclosure.

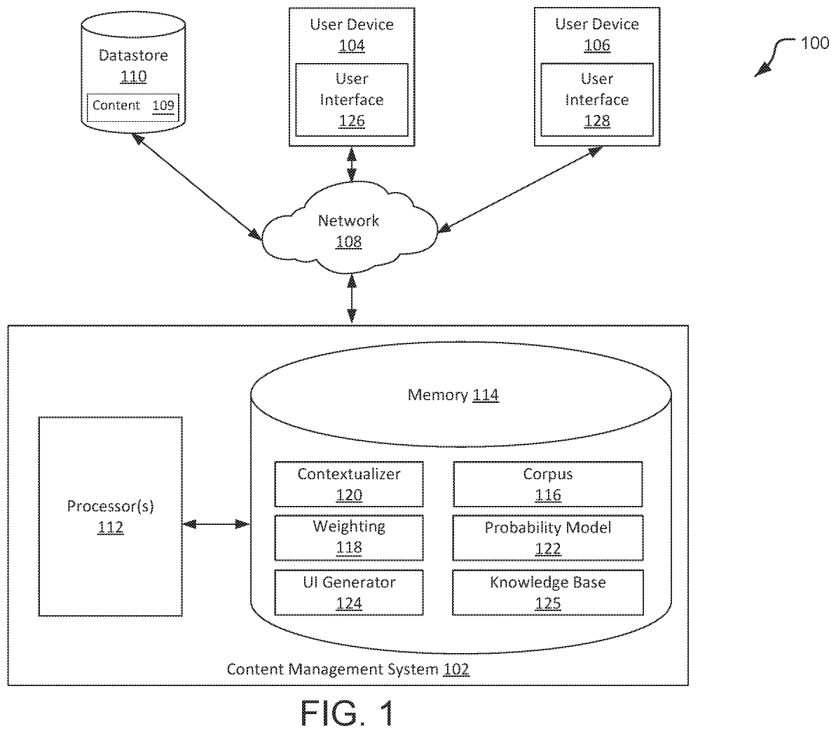

FIG. 1 illustrates an example system for a content management system 102 in accordance with various embodiments of the disclosure. Various user devices (e.g., user device 104 and 106 of FIG. 1) may connect to the content management system 102 to access and utilize the content management system 102. The user devices 104 and 106 may access the content management system 102 using a mobile application, web page, desktop application, or other methods. The content management system 102 may, in various examples, be hosted in a cloud computing environment, accessible by the user devices 104 and 106. In other examples, the content management system 102 may reside on one or more servers (e.g., web servers) accessible by the user devices 104 and 106 and the datastore 110.

Generally, the user devices 104 and 106 may be devices belonging to a user accessing the content management system 102. Such user devices 104 and 106 may be used, for example, to upload new content for inclusion in a knowledge base, to adjust the weighting of content in an existing knowledge base, to receive and/or transmit text that is received from the user, and the like. In various embodiments, additional user devices may be provided with access to the content management system 102. Where multiple user devices access the content management system 102, the user devices may be provided with varying permissions, settings, and the like, and may be authenticated by an authentication service prior to accessing the content management system 102. In various implementations, the user devices 104, 106, and/or additional user devices may be implemented using any number of computing devices included, but not limited to, a desktop computer, a laptop, a tablet, a mobile phone, a smart phone, a wearable device (e.g., AR/VR headset, smart watch, smart glasses, or the like), a smart speaker, a vehicle (e.g., automobile), or an appliance. Generally, the user devices 104 and 106 may include one or more processors, such as a central processing unit (CPU), graphics processing unit (GPU) and/or field programmable gate array (FPGA). The user devices 104 and 106 may generally perform operations by executing executable instructions (e.g., software) using the processors.

In some examples, the user interface 126 at the user device 104 and/or the user interface 128 at the user device 106 may be used to provide information (e.g., node weights, concept importance, etc.) to, and display information (e.g., content groupings and/or tags) from the content management system 102, and/or receive text provided by a user. In various embodiments, the user interface 126 and/or the user interface 128 may be implemented as a React, Javascript-based interface for interaction with the content management system 102. The user interface 126 and/or the user interface 128 may also access various components of the content management system 102 locally at the user devices 104 and 106, respectively, through webpages, one or more applications at the user devices 104 and 106, or using other methods. The user interface 126 and/or the user interface 128 may also be used to display content generated by the content management system 102, such as representations of the knowledge base, to user devices 104 and 106.

The network 108 may be implemented using one or more of various systems and protocols for communications between computing devices. In various embodiments, the network 108 or various portions of the network 108 may be implemented using the Internet, a local area network (LAN), a wide area network (WAN), and/or other networks. In addition to traditional data networking protocols, in some embodiments, data may be communicated according to protocols and/or standards including near field communication (NFC), Bluetooth, cellular connections, and the like. Various components of the system 100 may communicate using different network protocols or communications protocols based on location. For example, components of the content management system 102 may be hosted within a cloud computing environment and may communicate with each other using communication and/or network protocols used by the cloud computing environment.

The system 100 may include one or more datastores 110 storing various information and/or data including, for example, content and the like (e.g., content items 109). Content may include, in some examples, learning or informational content items and/or materials. For example, learning content items may include videos, slides, papers, presentations, images, questions, answers, and the like. Additional examples of learning content may include product descriptions, sound clips, and/or 3D models (e.g., DNA, CAD models). For example, the learning content may include testing lab procedures, data presented in an augmented reality (AR), virtual reality (VR), and/or mixed reality (MR) environment. In non-limiting examples, additional content that may be presented in an VR/AR/MR environment may include three-dimensional (3D) models overlaid in an AR environment, links of information related to product datasheets (e.g., marketing piece, product services offered by the company etc.), a script that underlies the video, and/or voice or text that may be overlaid in an AR environment. As should be appreciated, the content (e.g., content items 109 stored at datastore 110) can include various types of media, such as an existing video, audio or text file, or a live stream captured from audio/video sensors or other suitable sensors. The type and format of the content items may be varied as desired and as such the discussion of any particular type of content is meant as illustrative only.

In various implementations, the content management system 102 may include or utilize one or more hosts or combinations of compute resources, which may be located, for example, at one or more servers, cloud computing platforms, computing clusters, and the like. Generally, the content management system 102 is implemented by a computing environment which includes compute resources including hardware for memory 114 and one or more processors 112. For example, the content management system 102 may utilize or include one or more processors 112, such as a CPU, GPU, and/or programmable or configurable logic. In some embodiments, various components of the content management system 102 may be distributed across various computing resources, such that the components of the content management system 102 communicate with one another through the network 108 or using other communications protocols. For example, in some embodiments, the content management system 102 may be implemented as a serverless service, where computing resources for various components of the content management system 102 may be located across various computing environments (e.g., cloud platforms) and may be reallocated dynamically and automatically according to resource usage of the content management system 102. In various implementations, the content management system 102 may be implemented using organizational processing constructs such as functions implemented by worked elements allocated with compute resources, containers, virtual machines, and the like.

The memory 114 may include instructions for various functions of the content management system 102, which, when executed by the processor(s) 112, perform various functions of the content management system 102. For example, the memory 114 may include instructions for implementing a contextualizer 120, weighting 118, and a UI generator 124. The memory 114 may further include data utilized and/or created by the content management system 102, such as a corpus 116, a probability model 122, and/or a knowledge base 125. Similar to the processor(s) 112, the memory resources utilized by the content management system 102 and included in the content management system 102 may be distributed across various physical computing devices.

In various examples, when executed by the processor(s) 112, instructions for the contextualizer 120 may generate the corpus 116 from various content items (e.g., content items 109 stored at datastore 110), train and/or generate the probability model 122 to group concepts reflected in the corpus 116, and generate the knowledge base 125 using the probability model 122 and the content items. For example, the contextualizer 120 may process content items to generate the corpus 116. To process content items, the contextualizer 120 may generally convert content items into a data format which can be further analyzed to create the knowledge base 125. For example, the contextualizer 120 may include language processing, image processing, and/or other functionality to identify words within the content items and generate the corpus 116 including the significant and/or meaningful words identified from the content items. In various examples, the contextualizer 120 may use language and/or image processing to obtain words from the content items. The contextualizer 120 may then identify significant words using various methods, such as natural language processing to remove elements of the text such as extraneous characters (e.g., white space, irrelevant characters, and/or stem words extracted from the content) and remove selected non-meaningful words such as “to”, “at”, “from”, “on”, and the like. In forming the corpus, the contextualizer 120 may further remove newlines, clean text, stem and/or lemmatize words to generate tokens, remove common stop words, and/or clean tokens. In such examples, the corpus 116 may include groupings of meaningful words appearing within the content items (e.g., content items 109 stored at datastore 110).

The contextualizer 120 may generate the probability model 122 using the corpus 116. In various examples, the probability model 122 may be generated using topic modeling, such as a latent Dirichlet allocation (LDA). In various examples, the probability model 122 may include statistical predictions or relationships between words in the corpus 116. For example, the probability model 122 may include connections between words in the corpus 116 and likelihoods of words in the corpus 116 being found next to or otherwise in the same content item as other words in the corpus 116. In some examples, the probability model 122 may infer positioning on of documents or items in the corpus 116 in a topic.

In various examples, the contextualizer 120 may form content groupings when generating the probability model 122. For example, the process of training the LDA model may result in a set of topics or concepts. An example of a concept may include a combination of words that have a high probability for forming the context in which other phrases in the corpus 116 might appear. For instance, in creating a corpus 116 about ‘CRISPR’ (specialized stretches of DNA in bacteria and archaea), the model may include “guide RNA design” as a topic or concept because it includes a high probability combination of words that other words appear in the context of CRISPR. In some examples, a topic may be an approximation of a concept. Words that are found within close proximity with one another in the corpus 116 are likely to have some statistical relationship, or meanings as perceived by a human.

In other examples, a concept discovery algorithm may be used to find a topic or topics. A prior probability distribution, such as a Bayesian prior distribution, is an example of a weighted concept discovery algorithm. The prior probability distribution can be used with topic modeling (e.g., LDA) to find topics. A prior probability distribution can be used to represent the probability that a particular word will occur in a given topic. For example, if there are five (5) topics, the prior probability distribution for the five (5) topics can be represented by p(word)=[topic 1(prob), topic2(prob), topic3 (prob), topic4(prob), topic5(prob)]. The term “topic1(prob)” is the probability that the word “word” occurs in the first topic. The term “topic2(prob)” is the probability that the word “word” occurs in the second topic. The term “topic3(prob)” is the probability that the word “word” occurs in the third topic. The term “topic4(prob)” is the probability that the word “word” occurs in the fourth topic. The term “topic5(prob)” is the probability that the word “word” occurs in the fifth topic.

In one example, when there are five (5) topics, and it is expected that the word “word” is equally likely to occur in each topic, the prior probability distribution will be: p(word)=[0.2, 0.2, 0.2, 0.2, 0.2]. The sum of the probabilities for the five (5) topics equals one (1), meaning that the total probability of the word “word” belonging to any topic is one (1). In another example, if it is expected that the word “word” is more likely related to a particular topic, such as the first topic (topic1) out of the five (5) topics, the prior probability distribution can be p(word)=[0.8, 0.05, 0.05, 0.05, 0.05]. The total probability in this prior probability distribution still equals one (1), but the prior probability distribution reflects the assumption that it is more likely that the word “word” will be associated with the first topic.

Prior probability distributions can be used with text that is received from the user to find specific topics. In examples, the text includes a description or descriptions of the topic (e.g., free text topic description) and/or one or more groups of keywords that describe the topic. The prior probability distribution represents the expectation that the group of keywords will occur together. The highest probability is assigned to a particular topic (e.g., topic number) to increase the likelihood of finding the groups of keywords together in the same topic. With prior probability distribution, at least N+1 total topics are processed, where N is the number of user-defined groups of keywords.

A query expansion can be used to address the possibility of synonyms for the keywords that are chosen to use with prior probability distribution. A query expansion, such as a semantic similarity search, can find similar words to the keywords. Additionally or alternatively, free text that is supplied by the user can be processed using frequency analysis, such as term frequency-inverse document frequency, to extract the keywords from the user-supplied free text.

Once the probability model 122 is generated, the contextualizer 120 may generate the knowledge base 125 using the probability model 122 and the content items (e.g., content items 109 stored at datastore 110). The knowledge base 125 may be, in various examples, a graph or other type of relational or linking structure that includes multiple nodes, the nodes representative of various content items (e.g., content items stored at datastore 110). The nodes of the knowledge base 125 may store the content items themselves and/or links to such content items. The graph may include multiple edges between nodes, where the edges include weights representing probabilities of two corresponding topics (nodes) belonging to the same concept or related concepts. Such probabilities may be used to position nodes representing the content items relative to one another in space. In various examples, edges between nodes of the knowledge base 125 may be weighted, where the weight represents a strength of the relation between nodes connected by the edge. As such, the knowledge base 125 may represent sets of relationships between the content items (e.g., content items 109 stored at datastore 110) correlating to the knowledge base 125.

In generating the knowledge base 125, the contextualizer 120 may construct a graph of the knowledge base 125 by, for example, generating nodes of the knowledge base 125 from content items (e.g., content items 109 stored at datastore 110) and topics identified in the probability model 122. Generating the nodes may include placing the nodes within a space of the knowledge base 125 based on the concepts included in the content item associated with the node.

The contextualizer 120 may further group nodes of the knowledge base 125 into content groupings. In various examples, the contextualizer 120 may use a clustering algorithm (e.g., k-means clustering) to create content groupings and organize the nodes into clusters. For example, using k-means clustering, the contextualizer 120 may first generate a number of content groupings and determine centroids of the content groupings. In some examples, initial content groupings may be determined using the probability model 122. The contextualizer 120 may use a centroid value for the content groupings obtained from the probability model 122 or may initially assign a random value (e.g., spatial value) as a centroid of the content group. The contextualizer 120 may then assign each node of the knowledge base 125 to a content grouping based on the closest centroid to the node. Once all nodes have been assigned to a content group, new centroids may be re-calculated for each group by averaging the location of all points assigned to the content group. In various examples, the contextualizer 120 may repeat the process of assigning nodes to content groups and re-calculating centroids of the concept groups for a predetermined number of iterations or until some condition has been met (e.g., the initial centroid values match the re-calculated centroid values). As a result of the process of calculating the centroids, nodes may be assigned to content groups by the contextualizer 120. In various examples, the contextualizer 120 may use various types of clustering algorithms including k-means, k-medoids, DBScan, a Gaussian mixture model, or other algorithms to create content groupings and organize nodes into clusters to assign nodes to content groups.

In some examples, instructions for weighting 118 may create weighted nodes in the knowledge base 125. For example, the weighting 118 may access content items (e.g., content items 109 stored at datastore 110) associated with nodes in the knowledge base 125 and alter the content items to weight the node. In some examples, the weighting 118 may create a weighted node by manipulating a representation of a content item used to create the knowledge base 125. For example, nodes in the knowledge base 125 may be associated with vector embeddings representing the text of a content item, which embeddings may be created using neural-network based models, such as BERT. To create a weighted node, the weighting 118 may scale the embedding (e.g., multiply values in the embedding vector by a scalar value) to create the corresponding weighted node in the knowledge base 125.

In some examples, once a weighted node is created, the contextualizer 120 may adjust the knowledge base 125 based on the addition of the weighted node. For example, the weighting 118 may duplicate the text of a content item file, either within the file itself (e.g., multiplexing the content) or by creating copies of the file. In other examples, the weighting 118 may utilize a generative model (e.g., GPT or other generative language models) to paraphrase the text within a content item a certain number of times, effectively duplicating the concepts presented in the content item. The contextualizer 120 may then repeat the process of contextualization of the content items including the additional copies and/or updated files representing the weighted nodes. For example, the contextualizer 120 may generate the corpus 116 based on the updated content items, and/or re-generate the probability model 122 using the updated corpus 116 and generate an updated knowledge base 125 based on the updated content items and the re-generated probability model 122. The updated knowledge base 125 may include new content groupings and/or may be reshaped based on the additions of the gravity nodes to the knowledge base 125.

In some examples, instructions for weighting 118 may create a weighted concept discovery algorithm based on received text. For example, a prior probability distribution can be used with topic modeling to find topics based on the received text. As described later, the creation of weighted nodes and the creation of weighted concept discovery algorithms are part of user feedback that may be used to update the knowledge base 125.

When executed by the processor(s) 112, the instructions for UI generator 124 may access the knowledge base 125 to generate various user interfaces (e.g., user interface 126 and 128) at user devices utilizing and/or accessing the content management system 102. For example, UI generator 124 may display representations of the knowledge base 125, representations of content groupings (e.g., tags, concepts, or other indicators of concepts represented in a content grouping), user interfaces configured to receive input to create weighted nodes, to receive input to create weighted concept discovery algorithms, and the like.

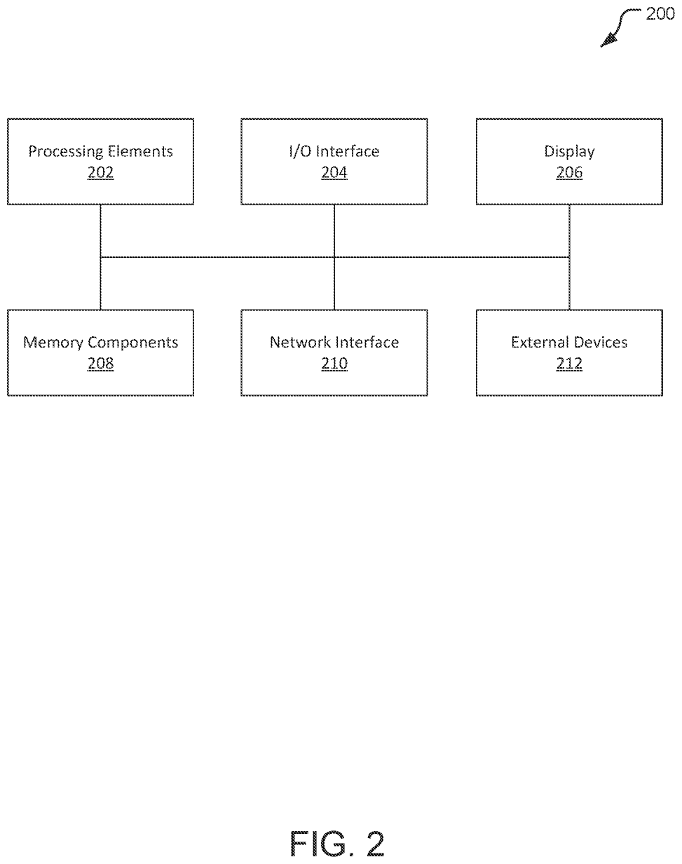

FIG. 2 shows a simplified block structure for a computing device 200 that may be used with the system 100 of FIG. 1 or integrated into one or more components of the system. For example, the content management system 102, user devices 104 and 106, or one or more other devices in communication with or included in the content management system 102 may include one or more of the components shown in FIG. 2 and be used to implement one or more blocks or execute one or more of the components or operations disclosed herein. In FIG. 2, the computing device 200 may include one or more processing elements 202, an input/output (I/O) interface 204, a display 206, one or more memory components 208, a network interface 210, and one or more external devices 212. Each of the various components may be in communication with one another through one or more busses, wireless means, or the like.

The one or more processing elements 202 may be any type of electronic device capable of processing, receiving, and/or transmitting instructions. For example, the processing element(s) 202 may be a central processing unit, a microprocessor, a processor, or a microcontroller. Additionally, it should be noted that some components of the computing device 200 may be controlled by a first processor and other components may be controlled by a second processor, where the first and second processors may or may not be in communication with each other.

The one or more memory components 208 are used by the computing device 200 to store instructions for the processing element(s) 202, as well as store data, such as the corpus 116, the probability model 122, the knowledge base 125, and the like. The memory component(s) 208 may be, for example, a magneto-optical storage, a read-only memory, a random-access memory, an erasable programmable memory, a flash memory, or a combination of one or more types of memory components.

The display 206 provides visual feedback to a user, such as displaying questions or content items or displaying recommended content, as may be implemented in the user interfaces 126 and/or 128 shown in FIG. 1. Optionally, the display 206 may act as an input element to enable a user to control, manipulate, and calibrate various components of the computing device 200. The display 206 may be a liquid crystal display, a plasma display, an organic light-emitting diode display, and/or other suitable display. In embodiments where the display 206 is used as an input, the display 206 may include one or more touch or input sensors, such as capacitive touch sensors, resistive grid, or the like.

The I/O interface 204 allows a user to enter data into the computing device 200, as well as provides an input/output for the computing device 200 to communicate with other devices or services. The I/O interface 204 can include one or more input buttons, touch pads, and so on.

The network interface 210 provides communication to and from the computing device 200 to other devices. For example, the network interface 210 allows the content management system 102 to communicate with the datastore 110, the user device 104, and/or the user device 106 via a communication network (e.g., the network 108 of FIG. 1). The network interface 210 includes one or more communication protocols, such as, but not limited to WI-FI®, Ethernet, BLUETOOTH®, and so on. The network interface 210 may also include one or more hardwired components, such as a Universal Serial Bus (USB) cable, or the like. The configuration of the network interface 210 depends on the types of communication desired and may be modified to communicate via WI-FI®, BLUETOOTH®, and so on.

The one or more external devices 212 are one or more devices that can be used to provide various inputs to the computing device 200. Example external devices include, but are not limited to, a mouse, a microphone, a keyboard, a trackpad, or the like. The external device(s) 212 may be local or remote and may vary as desired. In some examples, the external device(s) 212 may also include one or more additional sensors that may be used in obtaining user's assessment variables.

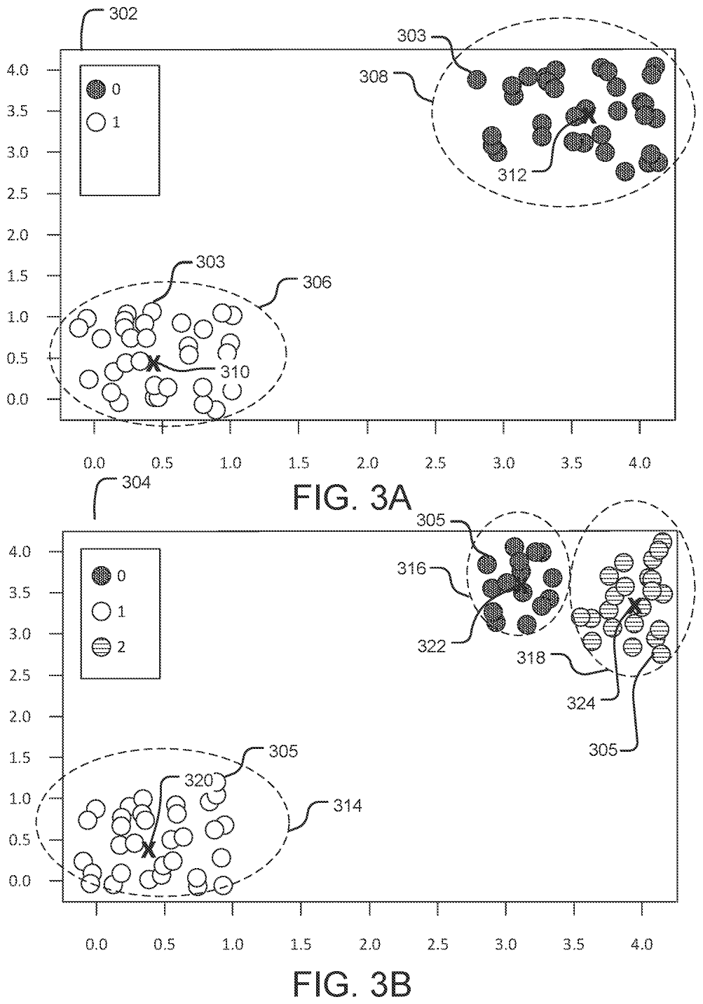

FIG. 3A illustrates a first example knowledge base 302 and FIG. 3B illustrates a second example knowledge base 304 updated with weighted nodes. The knowledge base 302 and the knowledge base 304 may be implemented using any of the methods and/or data structures described with respect to knowledge base 125 of FIG. 1. Nodes 303 in the knowledge base 302 and nodes 305 in the knowledge base 304 may be representations of content items of the knowledge bases. The knowledge base 302 generally includes nodes 303 representing content items and split into two content groupings 306 and 308, having centroids 310 and 312, respectively. Generally, the nodes 303 in the content grouping 306 are closer to the centroid 310 than to the centroid 312 of the content grouping 308. The knowledge base 304 includes nodes 305 representing content items and split into three content groupings 314, 316, and 318. Generally, the nodes 305 in content grouping 314 are closest to centroid 320, the nodes 305 in content grouping 316 are closest to centroid 322, and the nodes 305 in content grouping 318 are closest to centroid 324.

The content items included in the knowledge base 304 may be the same content items included in the knowledge base 302, but with one or more of the content items being represented by weighted nodes. As shown, such node weighting may affect the number of content groupings and/or the location of various centroids within content groupings. In the example shown, one or more nodes 303 left of the centroid 312 in content grouping 308 (FIG. 3A) and/or one or more nodes 303 right of the centroid 312 may be weighted to produce the knowledge base 304 (FIG. 3B). Accordingly, the knowledge base 304 has content groupings 316 and 318 in place of content grouping 308.

The knowledge base 304 may emphasize, via weighted nodes, concepts and/or content items not emphasized in the knowledge base 302. For example, nodes 303 to the left of the centroid 312 (FIG. 3A) may be conceptually different than nodes 303 to the right of the centroid 312. For example, conceptually different nodes may correspond to content items covering different concepts. However, the unweighted nodes are all within content group 318, and such nodes 305 are less likely to be recognized and/or considered as representing separate topics. By weighting one or more nodes (e.g., emphasizing content items corresponding to the nodes) in the content grouping 308 (FIG. 3A) to generate the knowledge model 304 (FIG. 3B), the separate concepts are recognized in the contextualization process, creating content groupings 316 and 318.

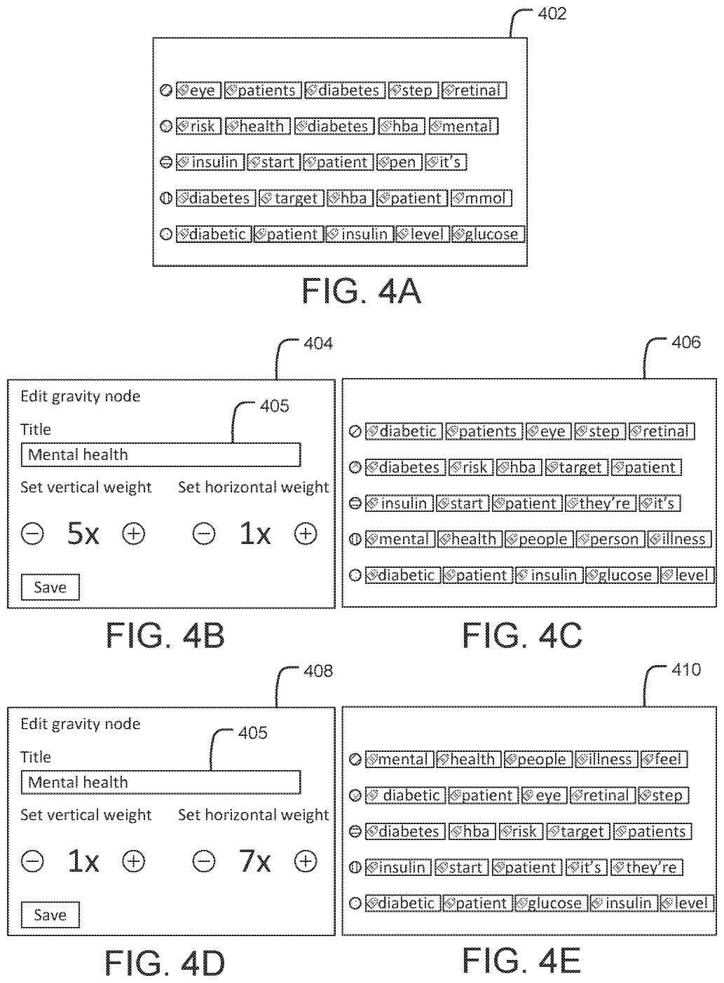

FIGS. 4A-4E illustrate example user interfaces showing concept groupings of content items with and without weighting of one or more nodes within a knowledge base. For example, user interface 402 in FIG. 4A shows groupings of content items where the knowledge base does not include weighted nodes. The tags may, for example, represent common words or concepts extracted from content within the content groupings (e.g., words in the corpus 116). In various examples, user interface 402 may be displayed with a knowledge base graph (e.g., knowledge base 302), showing clusters of nodes included in each of the content groups represented by the tags. In such examples, nodes of the knowledge base graph may be colored, patterned, and/or otherwise differentiated to display which nodes correspond to groupings of tags in the user interface 402.

The user interface 404 in FIG. 4B and the user interface 408 shown in FIG. 4D are example user interfaces for providing input to weight a node of a knowledge base. The user interfaces 404 and 408 may be displayed responsive to a user selecting a node within a knowledge base, navigating to a menu option, uploading a new content item, and/or otherwise selecting a content item. In some examples, the user interfaces 404 and 408 include fields 405 to name a new concept grouping created by weighting the node. Though shown with options to weight a node vertically or horizontally, the user interfaces 404 and 408 may, in some examples, provide one option to weight a node. In such examples, the node may be weighted horizontally and/or vertically depending on, for example, user adjustable settings and/or predetermined settings of the content management system 102 (FIG. 1). A user may adjust weighting of the selected node through the user interfaces 404 and 408 and when the content management system 102 receives such input, the weighting 118 may weight the corresponding content item and the contextualizer 120 may contextualize the updated content items.

In some examples, the user may input other information via a user interface, which information may be interpreted by the weighting 118 (FIG. 1) to determine how to weight the node corresponding to a content item. For example, when a user uploads a new content item, the user may be presented with a user interface asking the user how important the concepts represented by the content item are to the knowledge space as a whole. The user may then provide input using, for example, a slider ranging from “unimportant” to “extremely important,” a numeric rating, a selection of an importance level from multiple options, and the like. The weighting 118 may then weight the content item based on the input. In some examples, the user may order or rank several content items by relative importance. For example, the weighting 118 may correlate numeric weights with various inputs (e.g., a content item rated as unimportant is not weighted, while a content item rated as extremely important is weighted by a factor of 10). Accordingly, the content management system 102 may quantify importance on behalf of the user based on the user's subjective assessment of importance.

User interface 406 in FIG. 4C and user interface 410 in FIG. 4E are user interfaces showing content groupings created responsive to the weightings provided in the user interfaces 404 (FIG. 4B) and 408 (FIG. 4D), respectively. The content groupings shown in the user interfaces 406 and 410 may be content groupings generated by weighting a node in a knowledge base used to generate the content groupings shown in user interface 402 (FIG. 4A). For example, the knowledge base may include content items relating to mental health. In the content groupings shown in user interface 402 (FIG. 4A), such content items are not recognized, through the contextualization process, as belonging to a separate concept grouping from the other content items. For example, a tag for “mental” is included only in one content grouping, which also includes a tag for “diabetes,” indicated that the concept groupings are not well differentiated, and mental health may not be recognized as a separate concept. After a content item relating to mental health is weighted 5× through user interface 404 (FIG. 4B), the concept groupings are better differentiated, with the “mental” tag being included in a concept grouping separate from other concept groupings more clearly related to diabetes. After a content item related to mental health is weighted 7× through user interface 408 (FIG. 4D), the concept groupings show further differentiation and inclusion of additional mental health related tags in the concept grouping including “mental.” Accordingly, higher weights generally tend to place more emphasis on a topic within the knowledge base.

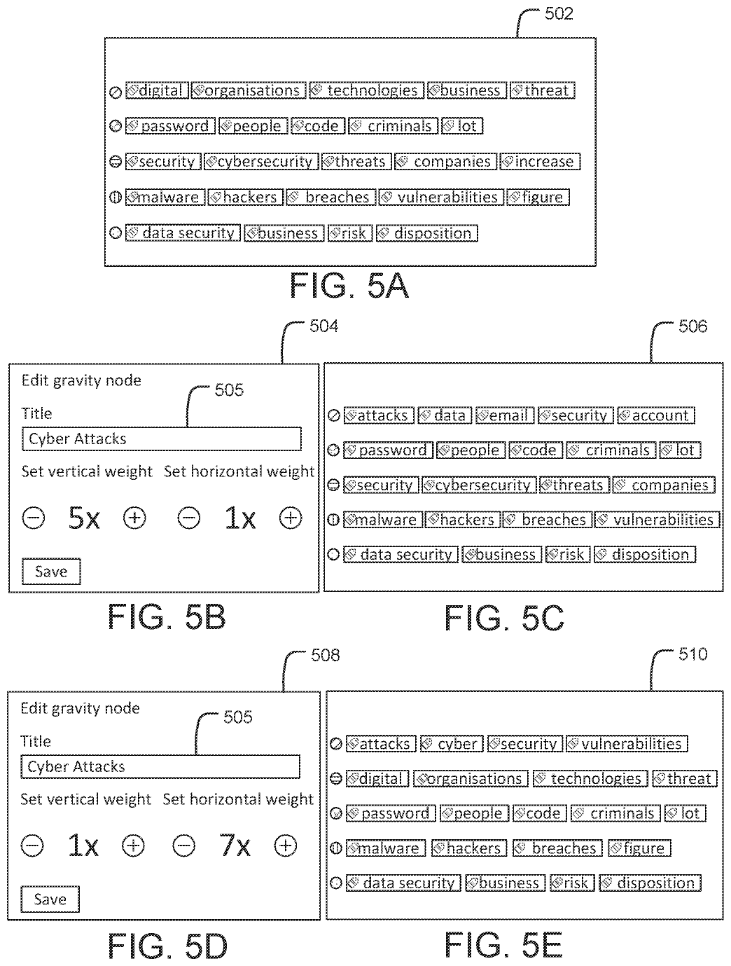

FIGS. 5A-5E illustrate additional user interfaces showing concept grouping of content items with and without weighting of one or more nodes within a knowledge base. User interface 506 shown in FIG. 5C and user interface 510 shown in FIG. 5E show content groupings created responsive to weightings provided in the user interface 504 (FIG. 5B) and the user interface 508 (FIG. 5D). The content groupings shown in the user interfaces 506 and 510 may be content groupings created by weighting a node in a knowledge based used to generate the content groupings shown in user interface 502 (FIG. 5A). The weightings shown in user interfaces 504 (FIG. 5B) and 508 (FIG. 5D) may be generated responsive to weighting a content item related to cyber attacks in field 505 to create the differentiated groups shown in the user interface 506 (FIG. 5C) and in the user interface 510 (FIG. 5E). As shown in FIGS. 4A-4E and FIGS. 5A-5E, the weighting described herein may be used to generate content groupings across a wide variety of subject areas.

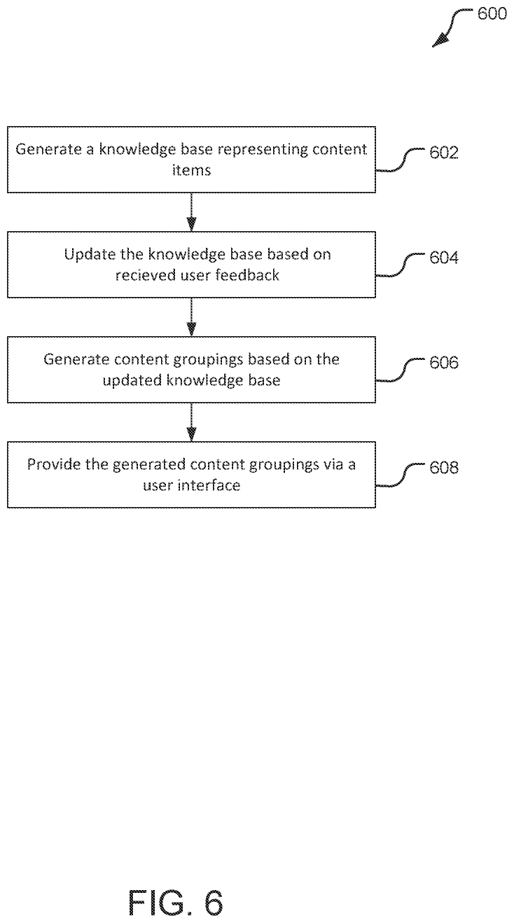

FIG. 6 is a flowchart illustrating an example method of generating content groupings in a knowledge base. At block 602, a content management system (e.g., the content management system 102 of FIG. 1) generates a knowledge base (e.g., knowledge base 125) representing content items (e.g., the content items 109 of FIG. 1). The content management system (e.g., the contextualizer 120 of FIG. 1) may generate the knowledge base by creating a corpus (e.g., corpus 116 of FIG. 1) from content items to be included in the knowledge base. A contextualizer may further create a probability model (e.g., probability model 122 of FIG. 1) using the corpus and may then generate the knowledge base using the probability model and the content items, as described herein (e.g., with respect to FIG. 1). When the knowledge base is generated, the contextualizer may further create content groupings within the knowledge base by applying a clustering algorithm or other unsupervised algorithm to the knowledge base. Such a clustering algorithm generally creates groupings of “like” nodes (e.g., nodes close to one another in the space of the knowledge base). When a clustering algorithm is applied to the knowledge base, the groupings represent conceptually similar content items.

In some examples, after the knowledge base is generated and content groupings are configured within the knowledge base, the content management system (e.g., UI generator 124 of FIG. 1) may display information about, or representations of, content groupings within the knowledge base. For example, the user interface 402 shown in FIG. 4A displays tags related to content groupings in a non-weighted knowledge base.

The content management system updates the knowledge base based on received user feedback at block 604. The user feedback may be a weight for a node of the knowledge base and/or received text that can be used to weight a concept discovery algorithm. The knowledge base is generally updated by weighting the node in accordance with instructions received from the user (e.g., through user interface 404 shown of FIG. 4B) and/or by weighting the concept discovery algorithm to enable one or more topics to be determined based on the received text. In various examples, a node may be weighted by increasing weight of the content item horizontally, increasing weight of the content item vertically, and/or increasing the magnitude of an embedding representing the content item.

To weight a node vertically, the content management system (e.g., the weighting 118 of FIG. 1) may duplicate the content or concepts of a content item in a single file. For example, the selected node may be linked or otherwise associated with a file containing text of the content item or text corresponding to the content item. The node weighting may access the file and duplicate the text within the file in order to increase the number of times concepts appear within the file. For example, where the vertical weight is set to 5× (e.g., in user interface 404 of FIG. 4B), the node weighting may replicate text within the file until the text appears five (5) times within the file. In another example, the node weighting may utilize a generative language model to paraphrase the text of a content item five (5) times, weighting the concepts presented within a content item. Such replication may be referred to as multiplexing the content of the file. After the node weighting multiplexes the content of the file, the contextualizer may repeat the contextualization process to update the knowledge base based on the weighted node. For example, the contextualizer may generate an updated corpus, the probability model, and the knowledge base based on the content items, including the newly updated content item.

To weight a node horizontally, the content management system (e.g., the weighting 118 of FIG. 1) may create multiple copies of files related to a content item. For example, where the horizontal weight is set to 7× (e.g., in the user interface 408 of FIG. 4D), the node weighting may create six (6) additional copies of the file in the content items (where the content item was already included in the knowledge base) or may upload seven (7) copies of the file to the content items (where the content item is newly uploaded). In some examples, the node weighting may use a generative model to paraphrase the text of a content item six (6) times and save each as a separate file, such that seven (7) files with the concepts presented in the content item exist (e.g., the original text of the content item and the text created by the generative model). After the additional copies are added to the content items, the contextualizer may repeat the contextualization process to update the knowledge base based on the weighted node. For example, the contextualizer may generate an updated corpus, an updated probability model, and an updated knowledge base based on the content items, including the newly updated content item.

The content management system (e.g., the weighting 118 of FIG. 1) may, in some examples, increase the weight of a node by increasing the magnitude of an embedding (e.g., a vector) representing the content associated with the node. For example, an embedding for text may be created using a transformer model (e.g., BERT), where the embedding is a real-value vector representing the text. In some examples, the contextualizer and/or other components of the content management system may create such an embedding when the knowledge base is initially created. In some examples, the node weighting may create an embedding when the node is selected to create a weighted node. The node weighting may then scale the embedding using a multiplier selected for creation of the weighted node. For example, if a user selects to create a weighted node using a 3× weight, the node weighting may scale the vector of the embedding by a factor of three (3) and may associate the scaled embedding vector with the node, creating a weighted node.

In some examples, the content management system may create a weighted node through a combination of vertical weighting, horizontal weighting, and/or increasing the magnitude of an embedding. For example, a user may select (e.g., via a user interface similar to user interface 404 of FIG. 4B and/or user interface 408 of FIG. 4D) to create a weighted node with both a horizontal and a vertical weight. The node weighting may then weight the content both vertically and horizontally by, for example multiplexing the content of a file within the file (weighting the node vertically) and then creating a number of copies of the multiplexed file (weighting the node horizontally). Similarly, to create a weighted node both vertically and by scaling an embedding, the node weighting may multiplex the content of a file within the file (weighting the node vertically), create an embedding of the multiplexed file, and scale the embedding vector by a scaling value to create the weighted node.

At block 606, the content management system generates content groupings based on the updated knowledge base. In various examples, the contextualizer may create concept groupings by first finding a number of concept groups. The number of concept groups may be provided by the user, selected by the contextualizer, received from or generated by the probability model, or a combination. For example, a new content group may be created to include the weighted node, such that the number of content groups may be determined by adding one concept group to a previous number of content groupings generated for the knowledge base.

After finding a number of content groupings, the contextualizer may use various clustering algorithms (e.g., k-means, k-medoids, DBScan, a Gaussian mixture model, or the like) to determine centroids for each of the groups and determine which nodes of the knowledge base should be included in the various content groups. In some examples, using k-means clustering, the contextualizer may initially assign a random value as the centroid of the group and then, for each node in the knowledge base, determine which centroid the node is closest to. In some examples, the contextualizer may initially utilize previous centroids and/or receive centroid estimations from the probability model. The node may then be assigned to a content group represented by the centroid. Once all nodes have been assigned to a content group, new centroids may be re-calculated for each group by averaging the location of all points assigned to the content group.

In various examples, the contextualizer may repeat the process of assigning nodes to content groups and re-calculating centroids of the concept groups for a predetermined number of iterations or until some condition has been met (e.g., the initial centroid values match the re-calculated centroid values). As a result of the process of calculating the centroids, nodes may be assigned to content groups by the contextualizer. Generally, the weighted nodes will affect the content groupings by affecting the calculations of the centroids. For example, a weighted node may be taken into account multiple times when calculating a mean value of all nodes in a content grouping, such that the centroid of the grouping is ultimately located closer to the weighted node than it would be without weighting the node. For example, a content item corresponding to a node weighted 5× is considered five (5) times in the averaging process instead of one time for an unweighted node. Accordingly, centroids are located closer to weighted nodes, making content represented by weighted nodes more likely to be categorized in its own content grouping.

The content management system provides the generated content groupings via a user interface at block 608. For example, the UI generator (e.g., UI generator 124 of FIG. 1) may format the content groupings based on preferences selected by the user or to match an output format. For example, the UI generator may generate content tags representing the content groupings (e.g., words appearing most frequently in content of a content grouping) and may display the groupings of tags corresponding to the content groupings (as shown, e.g., in the user interfaces 402, 406, and 410 of FIGS. 4A, 4C, and 4E, respectively). In some examples, such tags may be displayed in conjunction with a representation of the knowledge base including the content groupings (e.g., the knowledge base 302 of FIG. 3A and the knowledge base 304 of FIG. 3B). In various other examples, the UI generator may generate and display other representations of the content groupings, such as listings of content items in content groupings, a visual representation of the knowledge base including the content groupings, and/or other representations of the content groupings.

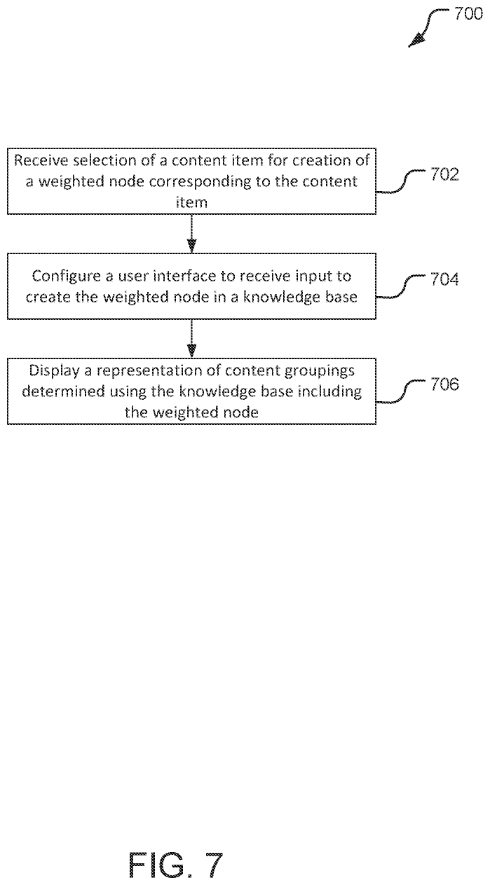

FIG. 7 is a flowchart illustrating an example method of generating content groupings using weighted nodes in a knowledge base through input from a user interface. A content management system (e.g., the content management system 102 of FIG. 1) receives a selection of a content item for creation of a weighted node corresponding to the content item at block 702. In some examples, the content item may be selected through a knowledge base (e.g., knowledge base 302 of FIG. 3A) or part of a knowledge base displayed at a user interface of a user device. The content item may further be selected from a list of content items in a knowledge base and/or be a content item being newly uploaded to the knowledge base. In some examples, after the user selects a content item, an UI generator (e.g., the UI generator 124 of FIG. 1) may configure and display additional menus or navigational elements providing a variety of actions the user can take with respect to the node and/or the content item, including creating a gravity node.

At block 704, the content management system (e.g., the UI generator 124 of FIG. 1) configures a user interface to receive input to create the weighted node in a knowledge base. For example, the UI generator may configure and display a user interface similar to the user interface 404 of FIG. 4B and the user interface 408 of FIG. 4D for receiving weights of weighted nodes. In some examples, the UI generator may generate user interfaces with other features for receiving input to create weighted nodes. For example, user interfaces may include sliders, fields to receive text input, buttons, checkboxes, or other elements for selecting weights for weighted nodes of the knowledge base.

The content management system (e.g., the UI generator 124 of FIG. 1) displays a representation of content groupings determined using the knowledge base including the weighted node at block 706. In various examples, the UI generator may display such representations (e.g., tags reflecting content groupings, as shown in the user interfaces 402, 406, and 410 of FIGS. 4A, 4C, and 4E, respectively) after passing the weighting inputs received at block 704 to other components of the content management system. For example, the node weighting (e.g., the weighting 118 of FIG. 1) may access the content item to modify a file corresponding to the content item in accordance with the weighting input, and the contextualizer (e.g., the contextualizer 120 of FIG. 1) may contextualize the updated content items, updating the knowledge base to reflect the weighted nodes (e.g., blocks 604, 606, and 608 of the method 600 of FIG. 6). In some examples, the UI generator may determine tags to display for each group by communications with the contextualizer. In some examples, the UI generator may further display a visual representation of the knowledge base, graphical representations of the content groupings (e.g., clusters of nodes), lists of content groupings, lists of content items in a content grouping, and the like.

Such output may be useful for a user to verify that the weighted node behaves as intended, e.g., that the correct concepts are being perceived as a distinct content grouping. For example, user interfaces including tags corresponding to content groupings may assist the user in assessing whether key words related to a desired concept are included in tags of a content grouping. Where they are not included, the user may increase the weight of the weighted node to better reflect the desired concepts. User interfaces displaying lists or other representations of content items in various content groupings may be similarly helpful in determining if content groups were created as desired. For example, some user interfaces may display a visual representation of the knowledge base, where hovering over a node of the knowledge base displays information about, or a preview of, a content item corresponding to the node. In such examples, the user may preview content items for nodes included in a content grouping to assess whether the content items included in the content grouping pertain to the desired concepts. Accordingly, output by UI generation 124 may assist users in further configuring a knowledge base to reflect desired concepts.

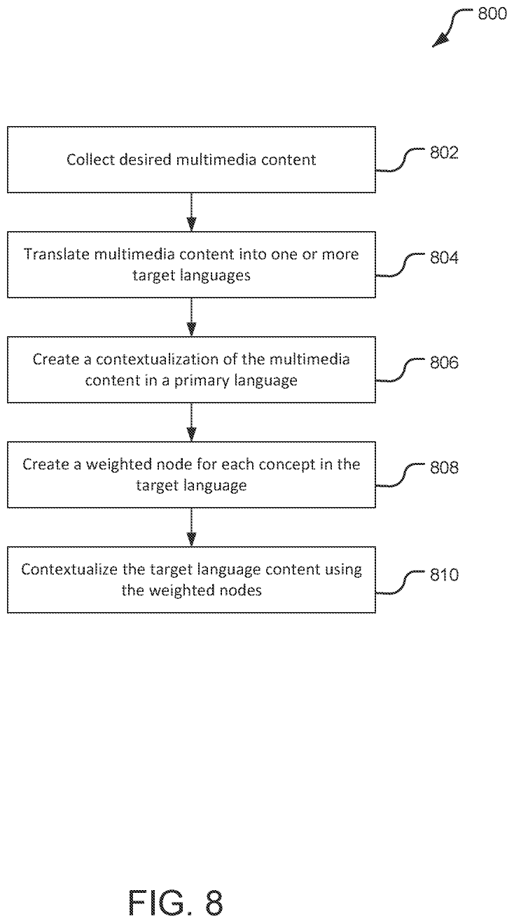

FIG. 8 illustrates an example method 800 of using weighted nodes to manage multimedia content across multiple languages. The method 800 may allow for the creation of learning modules (e.g., concept modules) across different languages, while providing a consistent adaptive learning experience across different languages. Further, knowledge spaces including the same content items in different languages may be correlated to one another such that, when a new content item is added to a knowledge space in the primary language, the same content item is added to knowledge spaces in one or more target languages in the correct location, without recontextualizing each of the separate knowledge spaces. Desired multimedia content is collected at block 802. The desired multimedia content may include various types of content (e.g., audio, video, textual, and other content) in one or more languages. In some examples, the multimedia content may be in a primary language.

At block 804, the multimedia content is translated into one or more target languages. In various examples, the multimedia content may be translated using various tools and/or algorithms, including Al translation algorithms. The multimedia content may, in various examples, be tagged or labeled with relevant information after being translated. For example, the content may be tagged with dates, version numbers, title, language, and/or other relevant metadata at block 804. A contextualization of the multimedia content in a primary language is created at block 806.

A weighted node is created for each concept in the target language at block 808. In one example, concepts are identified in the contextualization in the primary language created at block 806, and individual content items are assigned to an identified concept. For each identified concept, the target language versions of the content items assigned to the concept may be concatenated into a single content module (e.g., document), and a weighted node may be created for the content modules. After such concatenation and weighting is completed for each concept, the number of weighted nodes in the target language will match the number of concepts identified in the primary language.

At block 810, the target language content is contextualized using the weighted nodes. For example, a knowledge space may be generated using the weighted nodes, and the knowledge space may be contextualized using only the weighted nodes. After such contextualization, the content items in the target language may be added to the knowledge space. Generally, the knowledge space in the target language should match the knowledge space in the primary language such that corresponding content items are grouped in the same content groupings. In some examples, weights of the weighted nodes in the target language may be adjusted until each of the content items are in the correct content grouping. In various examples, after the content groupings are formed, the concepts may be renamed in the target language to match labels in the primary language.

The method 800 may be repeated for any number of target languages and may be used to provide the same content and/or adaptive learning experiences in a variety of languages. For example, a user may be able to select a desired language to learn a particular concept and may be presented with the same adaptive learning experience regardless of the language chosen.

The content management system with weighted nodes described herein may be used to improve various aspects of providing adaptive learning experiences. For example, content may be associated with various competency tags using various methods including cosign similarity measures between competency tags and content tags. Weighted nodes may be created for all content items having certain competency tags to further improve adaptive learning experiences and to help users gain desired competencies reflected by such competency tags.

In accordance with the above description, the content management system described herein is able to quickly adapt to new and changing content items. The knowledge base used by the content management system may be modified, through weighted nodes, to emphasize certain content items to suit the needs and preferences of various users, making the knowledge base adaptable for use in more situations. Accordingly, the knowledge base may more accurately reflect the actual importance of content items and relationships between content items, making the knowledge base useful in a wider variety of applications. For example, a knowledge base without the ability to create weighted nodes may be more difficult to use for delivering content that is frequently updated, such as in fields where regulations change frequently, or new technology is introduced frequently. Without the ability to weight the knowledge base, users may manually adjust large numbers (e.g., hundreds or thousands) of files in order to obtain a knowledge base representing desired concepts. Accordingly, the content management system described herein saves time by performing such adjustments based on user input regarding relative importance of content items added to the knowledge base.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method comprising:
generating a knowledge base including a plurality of nodes representing a respective plurality of content items;
updating the knowledge base based on a received user feedback, wherein the user feedback corresponds to a weighting for one or more content items;
generating content groupings based on the updated knowledge base, the content groupings including subsets of the plurality of content items, the subsets including conceptually similar content items; and
providing the generated content groupings via a user interface.

2. The method of claim 1, wherein:
the user feedback comprises a weighting for a selected node of the plurality of nodes of the knowledge base; and
updating the knowledge base based on the weighting for the selected node comprises updating a corpus representative of the plurality of content items to reflect the weight of the selected node and re-generating the knowledge base based on the updated corpus.

3. The method of claim 2, wherein updating the knowledge base based on the weighting for the selected node comprises accessing a text file corresponding to a content item of the plurality of content items, the content item corresponding to the selected node.

4. The method of claim 3, wherein updating the knowledge base based on the weighting for the selected node further comprises duplicating text in the text file corresponding to the content item based on the received weight for the selected node.

5. The method of claim 3, wherein updating the knowledge base based on the weighting for the selected node further comprises duplicating the text file corresponding to the content item based on the received weight for the selected node.

6. The method of claim 2, wherein the weighting for the selected node is received via the user interface.

7. The method of claim 1, wherein generating the content groupings based on the updated knowledge base comprises executing a clustering algorithm on the nodes of the updated knowledge base.

8. The method of claim 1, wherein providing the generated content groupings via the user interface comprises displaying a visual representation of the knowledge base via the user interface.

9. The method of claim 1, wherein:
the user feedback comprises received text; and
the weighting is based on the received text.

10. A method comprising:
receiving, via a user interface, a selection of a content item for creation of a weighted node corresponding to the content item;
configuring the user interface to receive input to create the weighted node by adjusting a weight of a node representing the selected content item, the node representing the content item in a knowledge base including a plurality of nodes representing a plurality of content items;
displaying, via the user interface, a representation of content groupings of the plurality of content items in the knowledge base, the content groupings being determined based on the plurality of nodes and the weighted node.

11. The method of claim 10, wherein the representation of the content groupings comprises tags corresponding with keywords representative of each of the content groupings.

12. The method of claim 10, further comprising:
displaying, via the user interface, a visual representation of the knowledge base with the representation of the content groupings of the plurality of content items in the knowledge base.

13. The method of claim 10, wherein the content groupings are determined by executing a clustering algorithm on the knowledge base including the weighted node.

14. The method of claim 10, wherein the selection of the content item is received as the content item is being added to the knowledge base.

15. A system, comprising:
a processor; and
a memory storing instructions, that when executed by the processor, cause operations to be performed, the operations comprising:
generating a knowledge base including a plurality of nodes representing a respective plurality of content items, the knowledge base representing a first set of relationships between the plurality of content items;
updating the knowledge base based on a received weight for a selected node of the plurality of nodes of the knowledge base, the updated knowledge base representing a second set of relationships between the plurality of content items;
generating content groupings based on the updated knowledge base, the content groupings including subsets of the plurality of content items, the subsets including conceptually similar content items; and
providing the generated content groupings via a user interface.

16. The system of claim 15, wherein updating the knowledge base based on the received weight for the selected node comprises updating a corpus representative of the plurality of content items to reflect the weight of the selected node and re-generating the knowledge base based on the updated corpus.

17. The system of claim 15, wherein updating the knowledge base based on the received weight for the selected node comprises accessing a text file corresponding to a content item of the plurality of content items, the content item corresponding to the selected node.

18. The system of claim 17, wherein updating the knowledge base based on the received weight for the selected node further comprises duplicating text in the text file corresponding to the content item based on the received weight for the selected node.

19. The system of claim 17, wherein updating the knowledge base based on the received weight for the selected node further comprises duplicating the text file corresponding to the content item based on the received weight for the selected node.

20. The system of claim 15, wherein generating the content groupings based on the updated knowledge base comprises executing a clustering algorithm on the nodes of the updated knowledge base.

21. The system of claim 15, wherein providing the generated content groupings via the user interface comprises displaying a visual representation of the knowledge base via the user interface.
